(19) United States
(12) Patent Application Publication
(10) Pub. No.: US 2022/0347938 A1
(43) Pub. Date: Nov. 3, 2022

(54) HYBRID COMPOSITE MATERIAL BETWEEN A METAL SURFACE AND A POLYMERIC MATERIAL SURFACE AND PROCESS FOR PRODUCING THE HYBRID COMPOSITE MATERIAL

(71) Applicant: Fraunhofer-Gesellschaft zur Foerderung der angewandten Forschung e. V., Munich (DE)

(72) Inventors: Kira van der STRAETEN, Aachen (DE); Arnold GILLNER, Roetgen (DE); Christoph ENGELMANN, Aachen (DE); Alexander OLOWINSKY, Aachen (DE)

(21) Appl. No.: 17/864,875

(22) Filed: Jul. 14, 2022

Related U.S. Application Data
(62) Division of application No. 16/326,627, filed on Feb. 19, 2019, now abandoned.

(30) Foreign Application Priority Data
Aug. 18, 2016 (DE) 10 2016 215 493.1

(51) Int. Cl. B29C 65/00; B23K 26/352; B29C 65/02

(52) U.S. Cl. CPC B29C 66/73161; B23K 26/3584; B29C 65/02; B29C 66/0246; B29C 66/7392; B29C 66/7394; B29C 66/742

(57) ABSTRACT

The invention is a hybrid composite material between a first joining partner having a metal surface and a second joining partner having a polymeric material surface. A process for producing a hybrid composite material associated therewith is also described. The hybrid composite material according to the invention is characterized in that the metal surface has microstructured depressions, having a diameter and a structure depth in the micrometer range, the microstructured depressions have metallic surface regions which are furnished entirely with nanostructures, the structure dimensions of which are in the nanometer range, the microstructured depressions are blind holes or throughhole openings fully passing through the first joining partner.

### CROSS REFERENCE TO RELATED APPLICATIONS

This application is a Divisional Application of U.S. Ser. No. 16/326,627, filed Feb. 19, 2019, which is the U.S. National Stage of PCT/EP2017/070931 filed Aug. 18, 2017, and German Application No. 10 2016 215 493.1 filed Aug. 18, 2016, which are incorporated herein by reference in their entirety.

### BACKGROUND OF THE INVENTION

### Field of the Invention

The invention relates to a hybrid composite material between a first joining partner having a metal surface and a second joining partner having a polymeric material surface and to a process for producing the hybrid composite material.

### DESCRIPTION OF THE RELATED ART

The term “hybrid composite material” is understood to describe a permanent joining connection between at least two joining partners of different material groups. The further considerations are limited to hybrid composite materials between a first joining partner of a metal material and a second joining partner of a polymer.

Accordingly, as a result of present demands for reduced weight with undiminished or improved strength properties, for example fiber composite components of carbon or glass fiber reinforced plastics in combination with metal components are becoming increasingly important. The particular challenge with regard to hybrid composite materials of such kind creating a durable, permanently strong joint between a metal surface and a plastic surface.

It is generally not possible to create an adhesive bond between plastics and metals due to the different melting temperatures and lack of chemical compatibility of the materials. However, good bonding strengths between metal and plastic surfaces can be created through thermal bonding by creating a form-locking joint. For this, a surface pretreatment must be carried out on the metallic joining surface by which surface structures are introduced into or onto the metallic joining surface and are at least one of filled with and surrounded by the plasticised synthetic material during a subsequent thermal joining process, thereby providing a mechanical clasping arrangement between the metal surface and the solidified plastic surface.

The metal surface may be modified appropriately by various methods including coating, sandblasting, milling or laser structuring. In this regard reference is made to A. Heckert, M. F Zaeh: “Laser Surface Pre-Treatment of Aluminium for Hybrid Joints with Glass Fibre Reinforced Thermoplastics”, In: Physics Procedia 56 (2014), S. 1171-1181, 2014 and A. Heckert, M. F Zaeh: “Laser Surface Pre-Treatment of Aluminium for Hybrid Joints with Glass Fibre Reinforced Thermoplastics,” In: Journal of Laser Applications 27 (S2), p. 29005-1-29005-5, (2015) is published.

In thermal joining, the metal and the polymeric joining partners are pressed against each other by the application of pressing forces. The polymeric joining partner, which usually is a thermoplastic material comes into contact with the metal joining partner at a common contact surface, via which the thermoplastic material in the joining zone, that is at least close to the contact surface is heated, typically by convection through the metal joining partner, and plasticised locally. The externally applied joining pressure causes the softened and plasticized plastic to be pressed into the structures of the metal joining partner where it solidifies after cooling.

To this effect, German document DE 10 2007 028 789 A1 describes a process for joining a metallic component to a component made from thermoplastic material in which the metal component is pressed into the thermoplastic component with the application of force while the metal component is heated by electromagnetic radiation and the thermoplastic material is plasticized and displaced locally in the contact region by the penetration process, and is encased by the plasticized thermoplastic material.

DE 10 2011 100 449 A1 describes a process for producing a composite body having at least one prefabricated metal component and at least one plastic component in which toothed engagement elements are indented on the joining surface of the metal component and are suitably dimensioned and bent out of the joining plane on the basis of a loading plan. Then, the metallic joining surface which is prefabricated in this way is coated with a plasticized synthetic material in a standard injection moulding process, and consequently the toothed engagement elements are anchored firmly inside the attached plastic component when the plastic solidifies. As an alternative to the indentation technique, it is logical to create suitable surface structures using a laser ablation process. Known laser ablation processes make use of both continuous and pulsed laser beam sources. When continuously emitting laser beam sources are employed, beam sources with high brilliance are used, so that the laser beam and the associated laser output can be focused on a very small area. During irradiation with a continuously emitting laser, the surface of the metal is melted locally, and the melt is removed from the area of interaction with the laser beam by surface vaporisation and the melting dynamics induced by the surface tension. At the fast scanning speed with which the laser beam passes over the metal surface to be processed, metal beads of re-solidified melt protruding above the metal surface form on both sides of the scanning track.

Depending on the scanning track selected, it is possible to create certain geometrical contours on the metal surface that is to be processed with the aid of such a process, for example in the shape of lines, intersecting lines or star structures, as is described in an article by A. Rösner, “Zweistufiges, laserbasiertes Fügeverfahren zur Herstellung von Kunststoff-Metall-Hybridbauteilen [Two-stage, Laser-Based Joining Process for Producing Plastic-Metal-Hybrid Components]”, Dissertation RWTH Aachen, 2014. If the geometric contours introduced into the metal surface by cw laser irradiation are traced several times with positional fidelity by the laser beam, depressions with “indentations” are formed and project progressively deeper into the metal surface, which in a subsequent joining process are filled with plasticized thermoplastic synthetic material and serve as mechanical clasping points or regions.

Structures with indentations can also be created in metal surfaces using pulsed laser beam sources, enabling a form-fitting joint of plastic and metal. To this effect, a process for producing a material assembly of metal and plastic to create a plastic-metal hybrid component in which at least one of stochastically arbitrarily distributed macroscopic and microscopic indentations are introduced into the metal surface by short-pulse laser irradiation to improve bonding is described in DE 10 2014 008 815 A1. The indentations created in the metal surface are then at least partly filled with a plasticized synthetic material in an injection moulding process, so that a respective clasping formation of the solidified synthetic material is produced in the indentations for a durable joint between the metal and plastic components.

DE 10 2007 023 418 B1 describes a further process for roughening particularly a metallic joining surface for the purpose of creating an improved joint between the metal surface and a plastic body, in which the metallic surface is irradiated with a pulsed laser beam that is directed towards the metal surface at a specifically predetermined angle of inclination and forms pockets that are aligned obliquely to the metal surface there, wherein the individual pockets form indentations relative to the metal surface. In a subsequent process step, the metal surface that is roughened in this way is coated with a thermal spray coating, particularly a LDS spray coating, in which the pockets are at least partly filled with plastic material and in this way a durable joint between the metal and plastic components is formed.

Document DE 10 2008 040 782 A1 discloses a micro- and nanostructured composite assembly which is designed to offer improved bonding between the two joining partner and additionally have a form-fitting connection.

All known laser structuring processes and the surface structures created therewith which serve as mechanical anchoring structures for a plastic joining partner that is joined to the correspondingly prefabricated metal surface in a thermal joining process are characterized by structure geometries in the millimetric or near-millimetric range. In this context, the effect that is responsible for connecting the two materials is always described as a form-fitting effect.

### SUMMARY OF THE INVENTION

The object of the invention is further developing a hybrid composite material between a first joining partner having a metal surface and a second joining partner having a polymeric material surface, and a process for producing an associated hybrid composite material in such manner that the joint qualities are improved significantly in terms of service life and composite strength. A particular objective is to improve the joint connection between the metal surface and the plastic surface without appreciably greater investment in terms of process technology and also costs. It is also essential to avoid any additives that have an effect on the joint.

Starting from a known hybrid composite material between a first joining partner having a microstructured metal surface and a second joining partner having a polymeric surface, in which the microstructured depressions protruding into the metal surface are at least partly filled with polymeric material, so that metallic surface regions assignable to the microstructured depressions are at least partly covered directly by the polymeric material surface of the second joining partner. The composite material according to the invention is characterized in that the metallic surface regions assignable to the microstructured depressions are completely nanostructured, wherein the microstructured depressions are constructed as blind holes or throughhole openings fully passing through the first joining partner and have aspect ratios, that is to say structural thickness/diameter ratios ≥5. At least one joint based on adhesion forces and/or covalent bonds is formed between the metallic surface regions of the microstructured depressions furnished with nanostructures of the first joining partner and the polymeric material surface of the second joining partner.

Thus it has been found according to the invention that the further provision of nanostructures on the existing microstructures gives rise to bonding forces in the form of at least one of adhesion forces and covalent bonding forces acting with surface adhesive action between the metal and the plastic surfaces, enabling significantly greater bonding strength to be achieved than is produced with hybrid material joints based solely on mechanical form fitting connections using indentations. Particularly the combination of mechanical clasping of the polymer with the microstructured metal and the nanostructure in the depressions and on the metal surfaces results in a significantly greater joint strength because the adhesion of the polymer to the metal surface is increased by increasing the specific adhesion with the nanostructures and this also prevents the polymer from being expressed from the depressions. At the same time, the macroscopic transfer of force takes place between the polymer component and the metal component via the mechanical clasping arrangement in the depressions of the metal component.

The microstructured depressions of the first metal joining partner furnished with nanostructures are preferably designed in such manner that a metallic surface assignable to the microstructured depressions is enlarged by at least a surface enlargement factor Δ of 1.5, particularly preferably Δ=3±0.5 as a result of the nanostructures. In this way, at least one of the adhesion forces and the covalent bonding forces acting between the metallic surface regions of the microstructured depressions furnished with nanostructures of the first joining partner and the polymeric material surface of the second joining partner may be increased significant, that is by at least 10%. This in turn also makes it much more difficult for the plastic to become detached from the microstructures covered with nanostructures, that is to say detachment of the form-fitting connection of the plastic inside the nanostructured microstructures.

The nanostructures are not necessarily but advantageously distributed in an even, preferably periodic arrangement over the microstructured metallic surface regions of the microstructures. Examinations of the structures according to the invention having the combination of nano- and microstructures has shown that the nanostructures in the form of local depressions or concave dents with dimensions from a few hundred up to one thousand nanometres are distributed over the microstructured metallic surface regions. The microstructured metallic surface regions covered with nanostructures particularly affect the inner walls of the microstructured depressions introduced into the metal surface.

It was also found that the effect according to the invention of at least one of the adhesion forces and covalent bonds between the metal and polymeric material surface is realized regardless of the arrangement and spatial alignment of either the microstructured depressions or the nanostructures covering the microstructured depressions. This means that in a preferred embodiment the microstructured depressions whose surfaces are covered with nanostructures are arranged without regard for the direction of other nanostructures. In other words they are arranged stochastically along the metal surface of the first joining partner.

Preferred materials and material combinations for creating a hybrid composite material constructed according to the invention are for example steel, aluminium, titanium or copper for the metal joining partner and polymers in the form of thermoplastics, thermosetting materials, hybrid polymers such as Ormocers to name just a few for the second joining partner with the polymeric material surface. In a preferred embodiment, the abovementioned polymer materials may also serve as a matrix material for a hybrid composite joint to which fiber or solid particle substances as well as dispersions may be added. In order to create the joint formed according to the invention between the two joining partners the polymeric material matrix That is selected in each case is of critical importance for the coating and the internal surface contact between the metal surface of the first joining partner and the polymeric material surface of the second joining partner based on at least one of adhesion and covalent bonds which are created thereby.

As was noted previously, the metal surface is irradiated repeatedly with ultra-short pulse laser radiation, that is at least one of laser pulse durations from 1 to 1000 picoseconds, and with laser pulse durations from 1 to 1000 femtoseconds for purposes of structuring the metal surface of the first joining partner. In this process, the pulsed laser beam is deflected dynamically by a scanning optics arrangement for projection onto the metal surface to be processed on the basis of a predetermined scanning pattern, so that individual metal surface regions or points are exposed repeatedly to laser pulses, preferably 10 to 50 times. As a result of each individual laser pulse application to the site on the metal surface, a local microerosion takes place in which metal vapor escapes, leading to a local material ablation and forming a microcavity. Depending on the laser parameters, nano- or microscale surface melts may also be created as well as the microablation, and these also contributed to a micro- and/or nanostructured surface. With at least a single repetition of a laser pulse application to a previously solidified microcavity, the laser radiation is absorbed by the bottom of the microcavity, creating metal melt again, which rises up the previously formed cavity walls and solidifies there. Metal vapor components also form inside the microcavity, and these rise according to the size and shape of the microcavity and solidify and are deposited on the lateral walls of the microcavity in a recondensation process. In this way, microstructured depressions with indentations are formed, on which the aforementioned mechanical clasping formations between the first and second joining partners are formed after filling correspondingly with polymeric material.

The use of an short pulse and particularly an ultra-short pulse laser beam has the effect of inducing for example at least one of interference phenomena and localized modulations of the interaction between the laser beam and the workpiece on the microcavities formed while the laser pulses are applied, which ultimately causes the formation of nanostructures on the metallic surface regions of the microstructuring depressions, and in particular on the inner walls of the microcavities that are created. According to current understanding of the processes initiated on the metal surface by the short pulse and ultra-short laser beam application, the irradiation field strength of the laser beam interacts or interferes with excited plasmons close to the surface in the form of periodic electron distributions in the metallic substance and or interacts with at least one of thermal, electronic and metallurgical surface tensions created on the metal surface, with the result that nanostructures are formed on the surface. These nanostructures also help significantly to increase the joint strength of the plastic-metal surface connection.

The nanostructures created in addition to the existing microstructures are able to influence the surface energy of the metal surface substantially and thus define the coating behavior inherent in the metal surface, thereby forming a significantly strong and technically usable adhesion effect between the metal and the plastic, particularly between the nano- and microstructured metal surface of the first joining partner and the polymeric surface of the second joining partner.

In order to improve the coating behavior of a metal surface with a polymeric material, it is important to adapt the surface energy of the metal surface to the surface energy of the polymeric surface. Depending on the specific surface energies of the polymer and the structured metal surface, the applicable laws can be described by the known theories according to Wenzel and Cassie-Baxter.

The combination of nanostructures and microstructures created on the metal surface of the first joining partner enables it to be covered entirely by a polymer in flowable form to produce a hybrid composite material based on additional adhesive action which surpasses that of a simple form-locking assembly.

After the abovementioned prefabrication of the structured metal surface of the first joining partner, the second joining partner, preferably having entirely polymeric material that must be joined to the structured metal surface of the first joining partner. This is preferably done in such manner that the polymeric material of the second joining partner is applied in flowable form either to the entire structured metal surface or in the area of the joining zone, so that the microstructured depressions are at least partly filled, thereby at least partly coating the micro- and nanostructured metallic surface regions of the microstructured depressions with the flowable polymer material. The coating operation is also supported by at least one of the adhesion forces and covalent bonding forces that are generated between the flowable polymer material and the nanostructured surface, thus optimizing the coating operation with the regard to a complete surface coating.

In a preferred process variant, the prefabricated nano- and microstructured metal surface is contacted under pressure by a second joining partner made of a thermoplastic. Then the thermoplastic material of the second joining partner is heated and plasticized at least locally in the region of the surface contact between the metal surface and the thermoplastic surface, so that the flowable thermoplastic material fills the microstructures of the metal surface and at least partly fills the nanostructures on the metallic surface regions of the first joining partner. Finally, the thermoplastic material cools and solidifies, forming the hybrid composite material according to the solution.

The local heating of the thermoplastic second joining partner preferably takes place within the joining zone by convective transfer of heat from the heated first joining partner, which is heated for example by induction, heating elements, ultrasound, laser radiation or IR radiators.

On the other hand, if the second joining partner is made of a thermosetting plastic, for example a curable resin, the polymeric material of the second joining partner does not need to be softened thermally. Instead the prestructured metal surface of the first joining partner is filled with the thermosetting plastic which is present in flowable form. In this case too, bonding forces based on at least one of adhesion forces and covalent bonds between the metal surface and the subsequently solidifying thermosetting plastic material surface of the second joining partner are generated between the thermosetting plastic and the micro- and nanostructured metal surface as well as the known form-fitting connections which form mechanical clasping arrangements.

The process according to the invention for producing a hybrid composite material between a first joining partner having a metal surface and a second joining partner having a polymeric material surface may also be modified advantageously by using the first joining partner with a prefabricated structured metal surface as an integral part in a process for producing a plastic component consisting of thermoplastic material. In this way for example, a correspondingly prefabricated metal component may be integrated as an additional component such as an insert in an injection molding, transfer molding, extrusion molding or laminating process. In this case, it is then not necessary to provide a second joining partner made of polymeric material, which must be present in flowable form or converted to a flowable form to enable the joint to be made.

The hybrid joint according to the invention between a metal and a polymeric joining partner may be characterized in summary by the following properties:
Stable connection between plastic and metal without use of adhesives or other additives.
The polymeric material practically completely fills the micro- and nanostructures created in the metal surface and uses mechanical clasping effects between the plastic and metal surfaces
The considerably enlarged active surface created by the micro- and nanostructuring of the metal surface affords improved use of physical forces at the nanolevel.
The good substantial strength generated by the hybrid composite material according to the invention is comparable with that of adhesive bonds.

### BRIEF DESCRIPTION OF THE DRAWINGS

In the following text, the invention will be described without limitation of the general inventive thought on the basis of exemplary embodiments thereof and with reference to the drawing. In the drawings:

FIG. 1 is a representation of the superimposed micro- and nanostructures for joining a plastic with a metal surface, and

FIGS. 2a, b show scanning electron microscope images of a prestructured metal surface

### WAYS TO IMPLEMENT THE INVENTION, COMMERCIAL APPLICABILITY

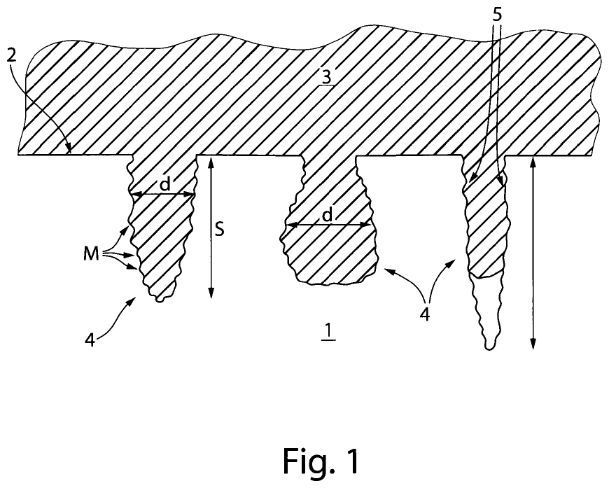

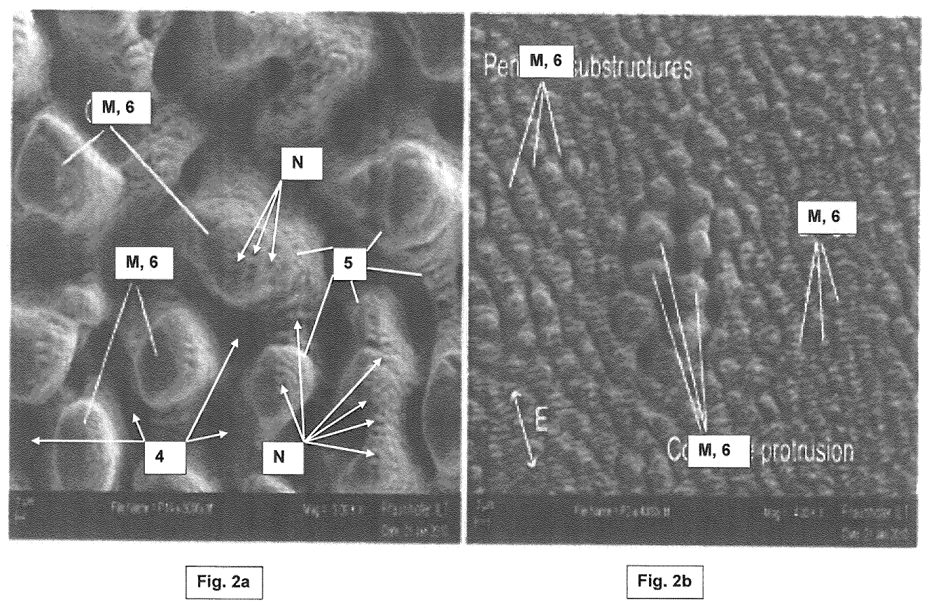

FIG. 1 represents a highly simplified hybrid joint between a first joining partner 1 having a metal surface 2 and a second joining partner 3 made from polymeric material. The metal surface 2 of the first joining partner 1 is furnished with microstructured depressions 4, whose maximum diameter d and structure depths S have dimensions between 1 μm and 1000 μm. The microstructured depressions 4 have microstructures M and nanostructures N represented in FIG. 1 on their inner walls 5, which are not illustrated in FIG. 1 and are illustrated in FIG. 2 corresponding to the metallic surface regions assigned to the microstructured depressions 4. The nanostructures N are superimposed over the microstructures M along the microstructured metallic surface regions 5.

The combination of microstructures M and nanostructures N may be seen in the scanning electron microscope image illustrated in FIG. 2a, which shows a top view of a surface region 5 of the metal surface 2 of the first joining partner 1 structured with the micro and nanostructures M, N. FIG. 2b shows detail of the micro and nanostructured metal surface 2 of the first joining partner reduced in size by factor of 2.

The aforementioned repeated irradiation of the metal surface 2 with at least one of shorts pulse and ultra-short pulse laser beams leads to the formation of depressions 4 which are below the metal surface 2 and which have a depth-to-width ratio (s/d) of at least a factor of 5. At least the metallic surface regions 5 closest to the individual depressions 4 are furnished with nanostructures N, which are shown as pores or dents in high contrast in the image representation of FIG. 2a.

The multiple arrangement of depressions 4 disposed side by side creates conical protrusions 6, also called CLPs, Cone Like Protrusions, the surfaces of which are preferably completely covered with nanostructures N. The conical protrusions 6 are formed by medium-sized to high fluences and particularly with short to ultra-short laser pulses in the picosecond and femtosecond range of the laser irradiation.

When a metal surface made for example of steel which is processed with a laser beam, and which is exposed repeatedly to at least one of short pulse laser beams and ultra-short pulse laser beams. The formation of the microstructured depressions 4 are manifested as single black hole-like structures. Characteristic of the structure formation on a steel surface is a continuously progressive black coloration of the metal surface.

The nanostructures N which are created in addition to the microstructures M during irradiation with ultra-short pulse lasers causes the surface-volume ratio to be enlarged substantially compared with a metal surface that has only been furnished with microstructures, and the surface area is rendered significantly more reactive to at least one of specific adhesion and covalent bonding than a joining partner that has only been provided with microstructures, so that at least one of the adhesive, covalently binding and bonding effect between a plastic surface and a metal surface structured in such manner is increased substantially or is raised to a technically usable level.

The metal surface structured according to the invention fulfils the prerequisite for a hybrid composite material with a significantly higher bonding strength, which is based on at least one of the adhesive and covalent bonding forces between the nanostructured microstructures and a polymeric substance or material. Thus in the first instance the microstructures function to create form-fitting bonds which are known per se, for example in the form of mechanical clasping arrangements, which serve to enable inherent, powerful force transfer, while the nanostructures are able to generate surface adhesion forces between the metal surface and the polymeric surface. The nanostructures are able to influence the surface energy of the metal surface significantly without any additives or intermediate layers.

The embodiment illustrated in FIGS. 2a and b which show the structuring of a metal surface reflects a further advantageous property beside the combination according to the solution of micro- and nanostructures, that is to say the principle of arrangement of self-organizing microstructures in the form of the previously noted CLP conical protrusions 6, each of which form around immediately adjacent micro and nanostructured depressions 4. The application of at least one of short laser pulses and ultra-short laser pulses to the metal surface to be structured is preferably carried out in such manner that the self-organizing microstructures 6 are formed in largely even distribution over an area without any other processing intervention.

### REFERENCE LIST

1 First joining partner
2 Metal surface
3 Second joining partner
4 Microstructured depressions
5 Metallic surface region, inner wall of the microstructured depressions
6 Conical bodies, CLP
M Microstructure
N Nanostructure
d Diameter
s Structure depth

1. A method for producing a hybrid composite material between a metal surface and a polymeric material surface, comprising:
structuring the metal surface with a laser pulse beam having a pulse duration in picoseconds or femtoseconds to produce microstructured depressions extending into the metal surface and each including metallic surfaces including microstructures and nanostructures, the microstructured depressions include one of blind holes or throughhole openings passing through the metal surface and have a thickness to diameter ratio of not less than 5, wherein the nanostructures cover the microstructured depressions;
applying polymeric material to the structured metal surface by coating at least part of the metal surface of the metal surface having nanostructures using flowable polymeric material; and
solidifying the polymeric material and forming at least one joining connection based on at least one of adhesion and covalent bonds between the solidified polymeric material and microstructured and nanostructured metal surface regions.

2. The method according to claim 1, comprising:
focusing a laser beam on the metal surface, deflecting the laser beam laterally so that micromelts are formed at each site on the metal surface, which partially vaporize and subsequently solidify to form microcavities; and
directing the laser beam at least once at each microcavity of forming a micromelt with metal vaporization in the microcavity.

3. The method according to claim 2, comprising:
directing at least one laser beam on a solidified microcavity so that the laser beam is absorbed at a bottom of the microcavity to cause a metal melt to form which rises up walls of the microcavity and solidifies.

4. The method according to claim 2, comprising:
applying a one laser beam at least once to a solidified microcavity so that the laser beam is absorbed at the bottom of the microcavity at which metal is vaporized to form a metal vapor which rises and recondenses on the walls of the microcavity.

5. The method according to claim 2, comprising:
applying the laser beam at a surface of a joining partner so that plasmons are excited at least one of thermal, electronic and metallurgical surface tensions are formed which interact with an irradiation field of the laser beam to form the nanostructures.

6. The method according to claim 2, comprising:
applying polymeric material of another joining partner including a thermoplastic material to the structured metal surface by pressing the joining partners together under pressure;
converting the thermoplastic material of one joining partner into flowable form by application of heat so that the flowable thermoplastic material fills the microstructures and at least partially coats nanostructures on the metallic surface regions of one of the joining partners; and
forming that the hybrid composite material by cooling and solidification of the thermoplastic material.

7. The method according to claim 1, comprising:
applying polymeric material in a form of the another joining partner comprising a thermosetting material by coating and filling the structured metal surface with the thermosetting material in a flowable state; and
forming the hybrid composite material by solidification of the thermosetting material.

8. The method according to claim 1, comprising:
using the first joining partner with a previously prepared structured metal surface as an integral component to manufacturing a plastic component comprising a thermoplastic material.
